(19) United States
(12) Patent Application Publication
(10) Pub. No.: US 2006/0073053 A1
(43) Pub. Date: Apr. 6, 2006

(54) Orbiting vane compressor

(75) Inventors: Seon-woong Hwang, Anyang-Si (KR); Dong-won Yoo, Seoul (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 11/111,862

(22) Filed: Apr. 22, 2005

(30) Foreign Application Priority Data
Oct. 6, 2004 (KR) 10-2004-0079609

(51) Int. Cl. F16N 13/20; F01C 20/18; F01C 1/02; F04C 2/00

(52) U.S. Cl. 418/29; 418/30; 418/59; 418/62

(57) ABSTRACT

Disclosed herein is an orbiting vane compressor having two compression chambers formed in a cylinder according to an orbiting movement of an orbiting vane. The orbiting vane compressor comprises a shell having an inlet tube and an outlet tube, the shell being hermetically sealed such that refrigerant gas is introduced through the inlet tube and is then discharged through the outlet tube, a rotary shaft disposed in the shell while being supported by upper and lower flanges, the rotary shaft being rotated by a drive unit, and a compression unit for compressing refrigerant gas introduced into a cylinder according to an orbiting movement of an orbiting vane, which is attached to the rotary shaft, and discharging the compressed refrigerant gas to the lower part of the cylinder.

### BACKGROUND OF THE INVENTION

1. Field of the Invention

The present invention relates to an orbiting vane compressor, and, more particularly, to an orbiting vane compressor having two compression chambers formed in a cylinder according to an orbiting movement of an orbiting vane, thereby improving compression capacity and performance of the orbiting vane compressor as compared to a conventional rotary compressor having a single compression chamber, accomplishing easy oil supply to a compression unit of the orbiting vane compressor, and accomplishing easy separation of oil from discharged gas.

2. Description of the Related Art

Generally, a vane compressor compresses air introduced into a cylinder according to an orbiting movement of a vane. FIG. 1 is a longitudinal sectional view illustrating the overall structure of a conventional vane compressor.

As shown in FIG. 1, the vane compressor comprises a compression unit 100 connected to a drive unit (not shown) via a rotary shaft 120. The compression unit 100 is hermetically sealed by upper and lower housings 110 and 110a. In the compression unit 100 is disposed an orbiting vane 140, which is attached to an eccentric part 120a of the rotary shaft 120 for performing an orbiting movement in the upper part of a cylinder 130 when the rotary shaft 120 is rotated.

The cylinder 130 is provided at the upper part thereof with a cylinder cover 131 having inner and outer outlet holes 131a and 131b. In the cylinder 130 is disposed an inner ring 132. Between the inner ring 132 and the inner wall of the cylinder 130 is defined an annular space 133. The orbiting vane 140 is provided at the upper part thereof with a circular vane 140a, which performs an orbiting movement in the annular space 133 of the cylinder 130. As a result, compression chambers are formed in the annular space 133 at the inside and the outside of the circular vane 140a.

The cylinder cover 131 is provided with an inlet hole 134 for allowing external air to be introduced into the cylinder 130. The inlet hole 134 is connected to an inlet tube 150, which vertically penetrates the upper housing 110. At a predetermined position of the circumferential part of the upper housing 110 is formed an outlet tube 160.

In the conventional vane compressor with the above-stated construction, external air is introduced into the cylinder 130 through the inlet tube 150 and the inlet hole 134. The air introduced into the cylinder 130 is compressed by the orbiting vane 140, which performs an orbiting movement in the cylinder 130 by power transmitted to the orbiting vane 140 from the drive unit via the rotary shaft 120. The compressed air is guided into the upper housing 110 through the inner and outer outlet holes 131a and 131b of the cylinder 130, and is then discharged out of the vane compressor through the outlet tube 160 of the upper housing 110.

It is impossible, however, to apply the conventional vane compressor with the above-stated construction and operation as a refrigerant compressor used in a refrigerator or an air conditioner.

More specifically, there is a negligible difference between the temperature of air before being compressed and the temperature of air after being compressed while there is a significant difference between the temperature of refrigerant gas before being compressed and the temperature of refrigerant gas after being compressed. Consequently, it is necessary to isolate a refrigerant gas inlet channel and a refrigerant gas outlet channel from each other, and to securely maintain refrigerant gas introduced into the cylinder in a low-temperature and low-pressure state.

In the conventional vane compressor, however, the inlet tube 150 extends through the inner space of the upper housing 110, into which compressed air is discharged. Consequently, when the conventional vane compressor is applied as a refrigerant compressor, low-temperature and low-pressure refrigerant gas introduced into the cylinder 130 through the inlet tube 150 is heated by high-temperature and high-pressure refrigerant gas, which has been compressed and discharged into the upper housing 110. As a result, the refrigerant gas is introduced into the cylinder in a high-temperature and low-pressure state, which decreases the volumetric efficiency of the compressor. Consequently, the compression performance of the compressor is deteriorated.

It can be seen from the above description that the refrigerant gas inlet channel and the refrigerant gas outlet channel must be isolated from each other without interference therebetween in order to ensure that the vane compressor performs the compression operation according to the orbiting movement of a vane as a refrigerant compressor.

When the inlet hole 134 is disposed above the circular vane 140a as described above, the sectional area of the refrigerant gas inlet channel, including the inlet tube 150 and the inlet hole 134, is limited to the radius of the compression chamber of the cylinder, i.e., the annular space 133 of the cylinder, which is relatively less than the height of the circular vane 140a. Consequently, it is impossible to increase the sectional area of the refrigerant gas inlet channel, which is necessary to reduce pressure loss.

When the inner and outer outlet holes 131a and 131b formed at the cylinder cover 131 are disposed adjacent to the outlet tube 160 of the upper housing 110, oil may be excessively discharged through the outlet tube 160.

### SUMMARY OF THE INVENTION

Therefore, the present invention has been made in view of the above problems, and it is an object of the present invention to provide an orbiting vane compressor having two compression chambers formed in a cylinder according to an orbiting movement of an orbiting vane, thereby improving compression capacity and performance of the orbiting vane compressor as compared to a conventional rotary compressor having a single compression chamber, accomplishing easy oil supply to a compression unit of the orbiting vane compressor, and accomplishing easy separation of oil from discharged gas.

It is another object of the present invention to provide an orbiting vane compressor that is capable of maintaining the seal between the interior of a shell, into which high-pressure refrigerant gas compressed by a compression unit is discharged, and an inlet port of the cylinder, through which low-temperature and low-pressure refrigerant gas is introduced into the cylinder.

In accordance with the present invention, the above and other objects can be accomplished by the provision of an orbiting vane compressor comprising: a shell having an inlet tube and an outlet tube, the shell being hermetically sealed such that refrigerant gas is introduced through the inlet tube and is then discharged through the outlet tube; a rotary shaft disposed in the shell while being supported by upper and lower flanges, the rotary shaft being rotated by a drive unit; and a compression unit for compressing refrigerant gas introduced into a cylinder according to an orbiting movement of an orbiting vane, which is attached to the rotary shaft, and discharging the compressed refrigerant gas to the lower part of the cylinder.

Preferably, the cylinder is provided at a predetermined position of the circumferential part thereof with an inlet port, which communicates with the inlet tube.

Preferably, the cylinder has an annular space defined therein, the annular space being divided into inner and outer compression chambers by a circular vane of the orbiting vane, which is inserted in the annular space.

Preferably, the inner and outer compression chambers communicate with a pair of inner and outer outlet ports formed at the lower part of the cylinder, respectively.

Preferably, the annular space is defined between an inner ring disposed at the lower part of the cylinder while being protruded upward inside the cylinder and the inner wall of the cylinder.

Preferably, the circular vane is formed at the upper part of a vane plate of the orbiting vane, and the orbiting vane further comprises: a boss eccentrically formed in the circular vane.

Preferably, the rotary shaft is connected to the boss, and wherein the rotary shaft has an oil supplying channel formed longitudinally therethrough.

Preferably, the circular vane is provided at a predetermined position of the circumferential part thereof with an opening.

Preferably, the orbiting vane further comprises: a slider disposed in the opening.

Preferably, the circular vane is provided at another predetermined position of the circumferential part thereof, adjacent to the position where the slider is disposed, with a through-hole for allowing refrigerant gas to be introduced into the circular vane therethrough.

Preferably, the through-hole communicates with the inlet port of the cylinder.

Preferably, the slider has linear sliding contact surfaces formed at the inner and outer ends thereof, respectively, one of the linear sliding contact surfaces of the slider being parallel with the other linear sliding contact surface of the slider, and the cylinder is provided at the inner circumferential part thereof with a linear sliding guide surface, and an inner ring, which is disposed in the cylinder, is provided at the outer circumferential part thereof with another linear sliding guide surface, the linear sliding guide surface of the cylinder being parallel with the linear sliding guide surface of the inner ring, whereby the slider performs a linear reciprocating movement along the linear sliding guide surface of the cylinder and the linear sliding guide surface of the inner ring while the linear sliding contact surfaces of the slider are in contact with the linear sliding guide surface of the cylinder and the linear sliding guide surface of the inner ring, respectively.

Preferably, the orbiting vane compressor further comprises: a muffler disposed below the lower flange for receiving compressed refrigerant gas discharged from the compression unit; and a refrigerant gas outlet channel for discharging the compressed refrigerant gas received in the muffler into the shell.

Preferably, the refrigerant gas outlet channel is vertically formed through one side of the compression unit inside the muffler such that the refrigerant gas outlet channel communicates with the interior of the shell.

Preferably, the refrigerant gas outlet channel is a refrigerant gas outlet pipe having one end connected in communication to the muffler and the other end communicating with the interior of the shell, the refrigerant gas outlet pipe being disposed outside the compression unit.

Preferably, the refrigerant gas discharged through the refrigerant gas outlet channel is discharged through the outlet tube, which is disposed above the inlet tube.

Preferably, the orbiting vane compressor further comprises: a collar fitted in the inlet tube of the shell, the collar being made of a material having a higher strength than that of the inlet tube and having a diameter slightly greater than the inner diameter of the inlet tube, the collar being forcibly fitted into the inlet tube such that the diameter of the inlet tube is slightly increased, whereby air-tightness is maintained between the shell and the inlet port of the cylinder.

Preferably, the inlet tube, which is inserted in the inlet port of the cylinder through the shell, is made of copper, and the collar is made of steel.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a longitudinal sectional view illustrating the structure of a conventional rotary compressor;

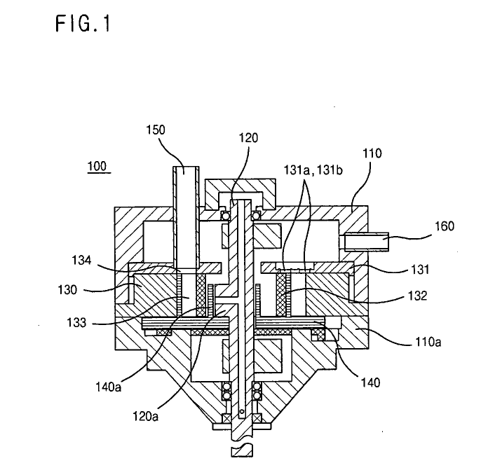

FIG. 2 is a longitudinal sectional view illustrating the overall structure of an orbiting vane compressor according to a preferred embodiment of the present invention;

FIG. 3 is a cross-sectional view illustrating the operation of a compression unit of the orbiting vane compressor according to the preferred embodiment of the present invention shown in FIG. 2;

FIG. 4 is an enlarged sectional view illustrating the “A” part of FIG. 2; and

FIG. 5 is a longitudinal sectional view illustrating the overall structure of an orbiting vane compressor according to another preferred embodiment of the present invention.

### DESCRIPTION OF THE PREFERRED EMBODIMENTS

Now, preferred embodiments of the present invention will be described in detail with reference to the accompanying drawings.

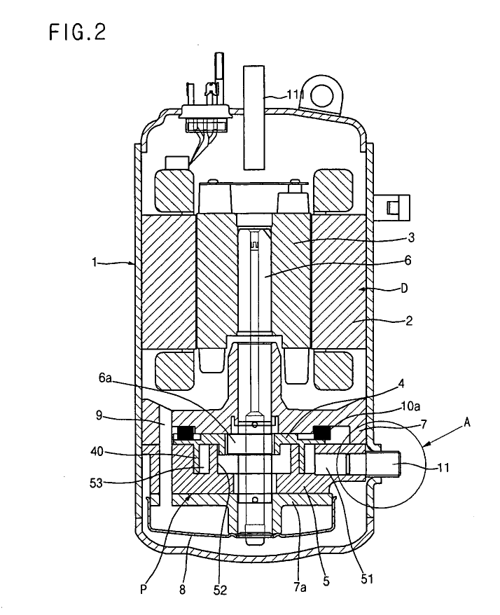

FIG. 2 is a longitudinal sectional view illustrating the overall structure of a hermetically sealed type orbiting vane compressor according to a first preferred embodiment of the present invention.

As shown in FIG. 2, a drive unit D and a compression unit P are mounted in a shell 1 while the drive unit D and the compression unit P are hermetically sealed. The drive unit D is disposed in the upper inner part of the shell 1, and the compression unit P is disposed in the lower inner part of the shell 1. The drive unit D and the compression unit P are connected to each other via a vertical rotary shaft 6. The rotary shaft 6 has an eccentric part 6a.

The drive unit D comprises: a stator 2 fixedly disposed in the shell 1; and a rotor 3 disposed in the stator 2 for rotating the rotary shaft 6, which vertically extends through the rotor 3, when electric current is supplied to the rotor 3.

The compression unit P comprises an orbiting vane 4 attached to the eccentric part 6a of the rotary shaft 6. As the orbiting vane 4 performs an orbiting movement in a cylinder 5, refrigerant gas introduced into the cylinder 5 through an inlet port 51 formed at a predetermined position of the circumferential part of the cylinder 5 is compressed. The cylinder 5 comprises an inner ring 52 integrally formed at the lower part thereof while being protruded upward. The orbiting vane 4 comprises a circular vane 40 formed at the lower part thereof while being protruded downward. The circular vane 40 performs an orbiting movement in an annular space 53 defined between the inner ring 52 and the inner wall of the cylinder 5.

Through the orbiting movement of the circular vane 40, inner and outer compression chambers are formed at the inside and the outside of the circular vane 50, respectively. Refrigerant gases compressed in the inner and outer compression chambers are discharged out of the cylinder 5 through inner and outer outlet ports (not shown) formed at the lower part of the cylinder 5, respectively.

To the lower part of the cylinder is attached a lower flange 7a, by which the lower part of the rotary shaft 6 is rotatably supported. Below the lower flange 7a is disposed a muffler 8, which communicates with a refrigerant gas outlet channel 9 vertically formed through one side of the compression unit P. Compressed refrigerant gas discharged from the compression unit P is guided into the shell 1 through the muffler 8 and the refrigerant gas outlet channel 9.

Unexplained reference numeral 11 indicates an inlet tube, 12 an outlet tube, and 10a an Oldham's ring for preventing rotation of the orbiting vane 4.

When electric current is supplied to the drive unit D, the rotor 3 of the drive unit D is rotated, and therefore, the rotary shaft 6 is also rotated. As the rotary shaft 6 is rotated, the orbiting vane 4 of the compression unit P, which is attached to the eccentric part 6a of the rotary shaft 6, performs an orbiting movement along a radius of the orbiting movement.

As a result, the circular vane 40 of the orbiting vane 4, which is inserted in the annular space 53 defined between the inner ring 52 and the inner wall of the cylinder 5, also performs an orbiting movement to compress refrigerant gas introduced into the annular space 53. At this time, the inner and outer compression chambers are formed at the inside and the outside of the circular vane 40 in the annular space 53, respectively. Refrigerant gases compressed in the inner and outer compression chambers are guided to the muffler 8, which is formed at the lower part of the shell 1, through the inner and outer outlet ports of the cylinder 5, which communicate with the inner and outer compression chambers, respectively, and are then discharged into the shell 1 through the refrigerant gas outlet channel 9. In this way, high-pressure refrigerant gas is discharged.

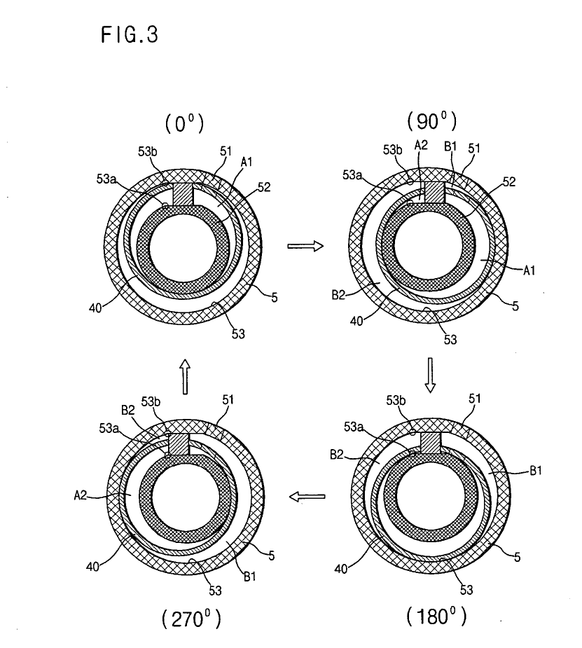

FIG. 3 is a cross-sectional view illustrating the operation of the compression unit P of the orbiting vane compressor according to the preferred embodiment of the present invention shown in FIG. 2.

When the orbiting vane 4 of the compression unit P is driven by power transmitted to the compression unit P from the drive unit D through the rotary shaft 6 (See FIG. 2), the circular vane 40 of the orbiting vane 4 disposed in the annular space 53 of the cylinder 5 performs an orbiting movement in the annular space 53 defined between the inner wall of the cylinder 5 and the inner ring 52, as indicated by arrows, to compress refrigerant gas introduced into the annular space 53 through the inlet port 51.

At the initial orbiting position of the orbiting vane 4 of the compression unit P (i.e., the 0-degree orbiting position), refrigerant gas is introduced into an inner suction chamber A1 of the circular vane 40 through the inlet port 51 as the inlet port 51 communicates with the inner suction chamber A1, and compression is performed in an outer compression chamber B2 of the circular vane 40 while the outer compression chamber B2 does not communicate with the inlet port 41 and an outer outlet port 53b. Refrigerant gas is compressed in an inner compression chamber A2, and at the same time, the compressed refrigerant gas is discharged out of the inner compression chamber A2.

At the 90-degree orbiting position of the orbiting vane 4 of the compression unit P, the compression is still performed in the outer compression chamber B2 of the circular vane 40, and almost all the compressed refrigerant gas is discharged out of the inner compression chamber A2 of the circular vane 40 through an inner outlet port 53a. At this stage, an outer suction chamber B1 appears so that refrigerant gas is introduced into the outer suction chamber B1 through the inlet port 51.

At the 180-degree orbiting position of the orbiting vane 4 of the compression unit P, the inner suction chamber A1 disappears. Specifically, the inner suction chamber A1 is changed into the inner compression chamber A2, and therefore, compression is performed in the inner compression chamber A2. At this stage, the outer compression chamber B2 communicates with the outer outlet port 53b. Consequently, compressed refrigerant gas is discharged out of the outer compression chamber B2 through the outer outlet port 53b.

At the 270-degree orbiting position of the orbiting vane 4 of the compression unit P, almost all the compressed refrigerant gas is discharged out of the outer compression chamber B2 of the circular vane 40 through the outer outlet port 53b, and the compression is still performed in the inner compression chamber A2 of the circular vane 40. Also, compression is newly performed in the outer suction chamber B1. When the orbiting vane 4 of the compression unit P further performs the orbiting movement by 90 degrees, the outer suction chamber B1 disappears. Specifically, the outer suction chamber B1 is changed into the outer compression chamber B2, and therefore, the compression is continuously performed in the outer compression chamber B2. As a result, the orbiting vane 4 of the compression unit P is returned to the position where the orbiting movement of the orbiting vane 4 is initiated. In this way, a 360-degree-per-cycle orbiting movement of the orbiting vane 4 of the compression unit P is accomplished. The orbiting movement of the orbiting vane 4 of the compression unit P is repeatedly performed in succession.

According this embodiment, the compression unit is characterized by a linear slider 10 that performs a linear reciprocating movement during the orbiting movement of the circular vane 40.

The linear slider 10 has a pair of linear sliding contact surfaces 10a, which are formed at the inner and outer ends thereof, respectively. Correspondingly, the cylinder 5 is provided at inner circumferential part with a linear sliding guide surface 10b having a predetermined length, and the inner ring 52 is provided at the outer circumferential part thereof with another linear sliding guide surface 10b having the same length as the linear sliding guide surface 10b of the cylinder 5. The linear sliding contact surfaces 10a of the linear slider 10 are parallel with each other. Similarly, the linear sliding guide surface 10b of the cylinder 5 is parallel with the linear sliding guide surface 10b of the inner ring 52.

When the circular vane 40 performs an orbiting movement in the cylinder 5, the linear slider performs a linear reciprocating movement along the linear sliding guide surface 10b of the cylinder 5 and the linear sliding guide surface 10b of the inner ring 52 while the linear sliding contact surfaces 10a of the linear slider 10 are in contact with the linear sliding guide surface 10b of the cylinder 5 and the linear sliding guide surface 10b of the inner ring 52, respectively.

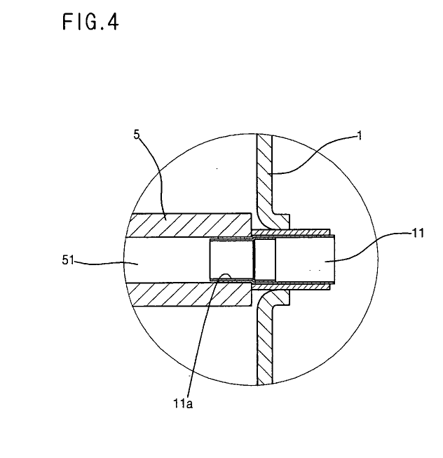

FIG. 4 is an enlarged sectional view illustrating “A” part of FIG. 2.

As shown in FIG. 4, the inlet tube 11 penetrates the shell 1 such that the inlet tube 11 is inserted into the inlet port 51 of the cylinder 5. In the inner circumferential part of the inlet tube 11 is fitted a collar 11a, which is made of a steel material having a higher strength than that of the inlet tube 11. Also, the collar 11a has a diameter slightly greater than the inner diameter of the inlet tube 11. The collar 11a is forcibly fitted into the inlet tube 11 by means of a machine tool such that the diameter of the inlet tube 11 is slightly increased. As a result, air-tightness is maintained between the shell 1 and the inlet port 51 of the cylinder 5.

Consequently, refrigerant gas is prevented from leaking through the space between the interior of the shell 1, where high-pressure refrigerant gas is filled, and the inlet port 51 of the cylinder 4, into which low-temperature and low-pressure refrigerant gas is introduced, and therefore, compression efficiency of the orbiting vane compressor is effectively prevented from being lowered.

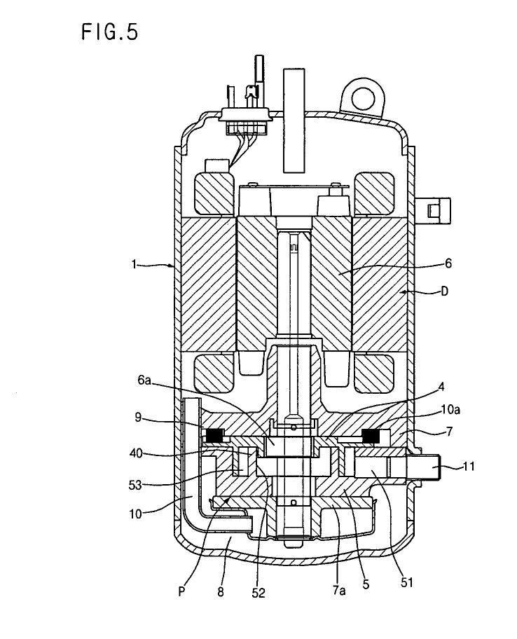

FIG. 5 is a longitudinal sectional view illustrating the overall structure of an orbiting vane compressor according to another preferred embodiment of the present invention.

The orbiting vane compressor according to this embodiment of the present invention is identical in construction and operation to the orbiting vane compressor according to the previously described embodiment of the present invention except that the orbiting vane compressor further comprises a refrigerant gas outlet pipe 10 having one end connected in communication to the muffler 8 and the other end communicating with the interior of the shell 1, the refrigerant gas outlet pipe 10 being disposed outside the compression unit P while the refrigerant gas outlet channel is vertically formed through one side of the compression unit inside the muffler in accordance with the previously described embodiment of the present invention. Accordingly, a further detailed description of the orbiting vane compressor according to this embodiment will not be given.

As apparent from the above description, two compression chambers are formed in the cylinder according to the orbiting movement of the orbiting vane, and the compression unit is disposed at the inner lower part of the shell while the drive unit is disposed at the inner upper part of the shell. Consequently, the present invention has the effect of improving compression capacity and performance of the orbiting vane compressor as compared to a conventional rotary compressor having a single compression chamber. Also, oil is easily supplied to the compression unit, and oil is easily separated from discharged gas while the discharged gas passes through the drive unit in accordance with the present invention. Consequently, the present invention has the effect of improving performance and reliability of the orbiting vane compressor.

Furthermore, the seal is maintained between the interior of the shell, into which high-pressure refrigerant gas compressed by the compression unit is discharged, and the inlet port of the cylinder, through which low-temperature and low-pressure refrigerant gas is introduced into the cylinder. Consequently, the present invention has the effect of improving compression efficiency of the orbiting vane compressor, and therefore, improving performance and reliability of the orbiting vane compressor.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An orbiting vane compressor comprising:
a shell having an inlet tube and an outlet tube, the shell being hermetically sealed such that refrigerant gas is introduced through the inlet tube and is then discharged through the outlet tube;
a rotary shaft disposed in the shell while being supported by upper and lower flanges, the rotary shaft being rotated by a drive unit; and
a compression unit for compressing refrigerant gas introduced into a cylinder according to an orbiting movement of an orbiting vane, which is attached to the rotary shaft, and discharging the compressed refrigerant gas to the lower part of the cylinder.

2. The compressor as set forth in claim 1, wherein the cylinder is provided at a predetermined position of the circumferential part thereof with an inlet port, which communicates with the inlet tube.

3. The compressor as set forth in claim 2, wherein the cylinder has an annular space defined therein, the annular space being divided into inner and outer compression chambers by a circular vane of the orbiting vane, which is inserted in the annular space.

4. The compressor as set forth in claim 3, wherein the inner and outer compression chambers communicate with a pair of inner and outer outlet ports formed at the lower part of the cylinder, respectively.

5. The compressor as set forth in claim 3, wherein the annular space is defined between an inner ring disposed at the lower part of the cylinder while being protruded upward inside the cylinder and the inner wall of the cylinder.

6. The compressor as set forth in claim 3, wherein
the circular vane is formed at the upper part of a vane plate of the orbiting vane, and
the orbiting vane further comprises: a boss eccentrically formed in the circular vane.

7. The compressor as set forth in claim 6, wherein the rotary shaft is connected to the boss, and wherein the rotary shaft has an oil supplying channel formed longitudinally therethrough.

8. The compressor as set forth in claim 3, wherein
the circular vane is provided at a predetermined position of the circumferential part thereof with an opening.

9. The compressor as set forth in claim 8, wherein the orbiting vane further comprises: a slider disposed in the opening.

10. The compressor as set forth in claim 9, wherein the circular vane is provided at another predetermined position of the circumferential part thereof, adjacent to the position where the slider is disposed, with a through-hole for allowing refrigerant gas to be introduced into the circular vane therethrough.

11. The compressor as set forth in claim 10, wherein the through-hole communicates with the inlet port of the cylinder.

12. The compressor as set forth in claim 9, wherein
the slider has linear sliding contact surfaces formed at the inner and outer ends thereof, respectively, one of the linear sliding contact surfaces of the slider being parallel with the other linear sliding contact surface of the slider, and
the cylinder is provided at the inner circumferential part thereof with a linear sliding guide surface, and an inner ring, which is disposed in the cylinder, is provided at the outer circumferential part thereof with another linear sliding guide surface, the linear sliding guide surface of the cylinder being parallel with the linear sliding guide surface of the inner ring,
whereby the slider performs a linear reciprocating movement along the linear sliding guide surface of the cylinder and the linear sliding guide surface of the inner ring while the linear sliding contact surfaces of the slider are in contact with the linear sliding guide surface of the cylinder and the linear sliding guide surface of the inner ring, respectively.

13. The compressor as set forth in claim 1, further comprising:
a muffler disposed below the lower flange for receiving compressed refrigerant gas discharged from the compression unit; and
a refrigerant gas outlet channel for discharging the compressed refrigerant gas received in the muffler into the shell.

14. The compressor as set forth in claim 13, wherein the refrigerant gas outlet channel is vertically formed through one side of the compression unit inside the muffler such that the refrigerant gas outlet channel communicates with the interior of the shell.

15. The compressor as set forth in claim 13, wherein the refrigerant gas outlet channel is a refrigerant gas outlet pipe having one end connected in communication to the muffler and the other end communicating with the interior of the shell, the refrigerant gas outlet pipe being disposed outside the compression unit.

16. The compressor as set forth in claim 13, wherein the refrigerant gas discharged through the refrigerant gas outlet channel is discharged through the outlet tube, which is disposed above the inlet tube.

17. The compressor as set forth in claim 1, further comprising:
a collar fitted in the inlet tube of the shell, the collar being made of a material having a higher strength than that of the inlet tube and having a diameter slightly greater than the inner diameter of the inlet tube, the collar being forcibly fitted into the inlet tube such that the diameter of the inlet tube is slightly increased, whereby air-tightness is maintained between the shell and the inlet port of the cylinder.

18. The compressor as set forth in claim 17, wherein the inlet tube, which is inserted in the inlet port of the cylinder through the shell, is made of copper, and the collar is made of steel.
